(19) United States
(12) Patent Application Publication
(10) Pub. No.: US 2009/0200776 A1
(43) Pub. Date: Aug. 13, 2009

(54) Side airbag apparatus

(75) Inventors: Yuji Sato, Aichi-ken (JP); Kensaku Honda, Aichi-ken (JP); Koji Shibayama, Aichi-ken (JP); Atsushi Nagata, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/320,608

(22) Filed: Jan. 30, 2009

(30) Foreign Application Priority Data
Feb. 13, 2008 (JP) 2008-032296

(51) Int. Cl. B60R 21/20

(52) U.S. Cl. 280/730.2

(57) ABSTRACT

A side airbag apparatus includes a flat airbag formed of a pair of base fabric sheets, which are stacked in the widthwise direction of a vehicle. The airbag is stored in an outer side portion of a seat back portion of a vehicle seat. Inflation gas is supplied to the airbag in response to an impact from the exterior. This inflates and deploys the airbag between a body side portion of the vehicle and the vehicle seat. A pair of tucked portions are located rearward of a center of the airbag. The tucked portions are formed by folding parts of the airbag. The tucked portions are joined to each other while being vertically stacked. Further, the width of the airbag along the widthwise direction of the vehicle in the vicinity of the tucked portions when the airbag is inflated is larger than the width of a rear portion of an airbag having no tucked portion along the widthwise direction of the vehicle when the airbag is inflated.

### BACKGROUND OF THE INVENTION

The present invention relates to a side airbag apparatus that, when an impact is applied from the exterior of a vehicle, inflates and deploys an airbag between a body side portion of the vehicle and an occupant seated on a vehicle seat to restrain the occupant with the airbag, thereby protecting the occupant from the impact.

For example, Domestic re-publication of PCT international application No. 2002-100691 discloses a side airbag apparatus. This apparatus protects an occupant seated on a seat from an impact due to a side collision that is applied to a side portion of the vehicle body such as a side door. In this apparatus, when an impact is applied to the body side portion from the exterior, an inflator discharges inflation gas into an airbag. The airbag is referred to as a flat bag. The airbag is formed by stacking a connected pair of base fabric sheets or a pair of independent fabric sheets, and joining the peripheral portions. When inflation gas is supplied into the airbag, the airbag pops out of a seat back (backrest portion) and is inflated and deployed in a narrow space between the occupant and the body side portion. The inflated airbag restrains the occupant and reduces the impact applied to the occupant from the exterior via the body side portion.

In the side airbag apparatus disclosed in Domestic re-publication of PCT international application No. 2002-100691, sewing is performed with the front end and the rear end of the bottom of the airbag being pinched. At the inflation and deployment of the airbag, a portion of the airbag between the sewn portions is located directly above the seat cushion (seat portion). The airbag is inflated so as to have a flat shape substantially parallel to the seating face of the seat cushion. Thus, the airbag is inflated with a larger thickness along the widthwise direction of the vehicle (lateral direction) in a section that corresponds to the lumbar region of the occupant, that is, in a section in the vicinity of the seating face of the seat cushion. This enhances the occupant restraining performance of the airbag.

However, according to the configuration of the above document, the bottom of the airbag is flat in a large area and its thickness along the lateral direction is great in the vicinity of the seating face of the seat cushion. Therefore, the bottom of the airbag cannot easily enter the narrow space between the lumbar region of the occupant and the body side portion.

Such a drawback is particularly disadvantageous in the case where a flat airbag is used. If the number of base fabric sheets is increased so that the airbag has a three-dimensional structure, the airbag can be inflated and deployed into a desired shape and the above described drawback is eliminated. However, the manufacture of three-dimensional airbags is complicated compared to that of flat airbags. Further, an airbag is stored in a seat back in a folded state. In this regard, a three-dimensional airbag is harder to fold than a flat airbag. Therefore, the manufacturing costs of a three-dimensional airbag are higher than those of a flat airbag.

### SUMMARY OF THE INVENTION

Accordingly, it is an objective of the present invention to improve the deployment performance of a side airbag apparatus using a flat airbag, while ensuring the restraining performance.

To achieve the foregoing objective and in accordance with one aspect of the present invention, a side airbag apparatus including an airbag and an inflator is provided. The airbag is formed by stacking a connected pair of base fabric sheets or a pair of independent fabric sheets, and joining peripheral portions of the base fabric sheets. The airbag is stored in a storage portion located in the vicinity of an outer side of an occupant seated on a vehicle seat. The inflator supplies inflation gas to the airbag in response to an impact applied to the vehicle from the exterior. The airbag is inflated and deployed between a body side portion of the vehicle and the vehicle seat. The side airbag apparatus further includes at least one pair of tucked portions located rearward of a center portion of the airbag and a joining portion. The tucked portions are formed by folding a part of the airbag. The joining portion joins the tucked portions to each other in a vertically stacked state. The width of the airbag along the widthwise direction of the vehicle in the vicinity of the tucked portions when the airbag is inflated is larger than the width of a rear portion of an airbag having no tucked portion along the widthwise direction of the vehicle when the airbag is inflated.

### BRIEF DESCRIPTION OF THE DRAWINGS

FIG. 1 is a side view illustrating a vehicle seat on which a side airbag apparatus according to one embodiment of the present invention is mounted;

FIG. 2 is a plan view showing the positional relationship between the vehicle seat and a body side portion;

FIG. 3 is a side view illustrating the airbag module in a state where the airbag is deployed without being filled with inflation gas;

FIG. 4 is a side view illustrating an inflator assembly;

FIG. 5 is a plan view of the airbag module of FIG. 4, as viewed from diagonally behind;

FIG. 6 is a rear view showing the inflated and deployed airbag;

FIG. 7 is a plan view showing the inflated and deployed airbag;

FIG. 8 is a rear view showing a portion of the airbag in a state where a rear portion is spread before forming tucked portions;

FIG. 9 is an enlarged cross-sectional view showing the inner structure of section X in FIG. 3;

FIG. 10 is a cross-sectional plan view showing the inner structure of section Y in FIG. 7; and

FIG. 11 is a side view showing an airbag according to a modified embodiment, in which tucked portions are provided in arcuate peripheral portions.

### DETAILED DESCRIPTION OF THE PREFERRED EMBODIMENTS

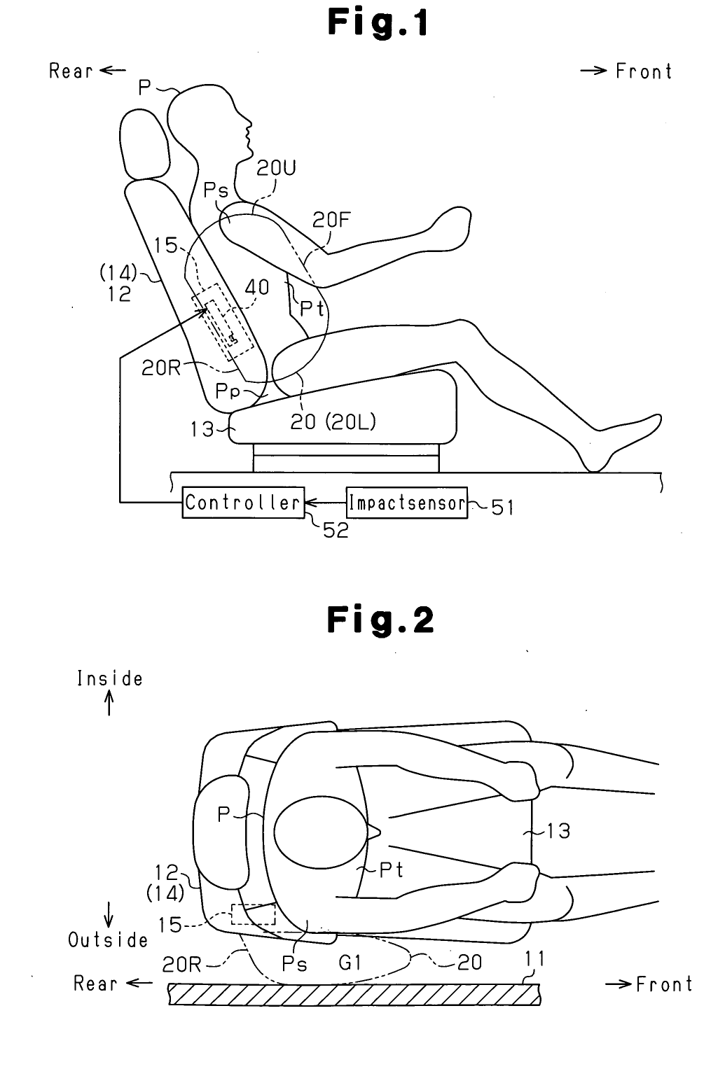

A preferred embodiment of the present invention will now be described with reference to FIGS. 1 to 10.

In the following, the direction in which a vehicle advances forward will be referred to as a forward direction, and the up-down direction of the vehicle is referred to as an up-down direction. A widthwise direction of the vehicle, or a lateral direction, is defined with reference to the forward direction and the up-down direction of the vehicle. In an airbag, a front-rear direction and an up-down direction are defined with reference to an inflated and deployed state.

As shown in FIGS. 1 and 2, a vehicle seat 12 is arranged on the inner side (upper side as viewed in FIG. 2) of a body side portion 11 of the vehicle. The body side portion 11 refers to a member that is located at a side of the vehicle. Part of the body side portion 11 corresponding to the front seat includes a front door, a center pillar (B-pillar), and the like. Part of the body side portion 11 corresponding to the rear seat includes a rear part of the side door (rear door), a C-pillar, a front part of the wheel well, a rear quarter, and the like.

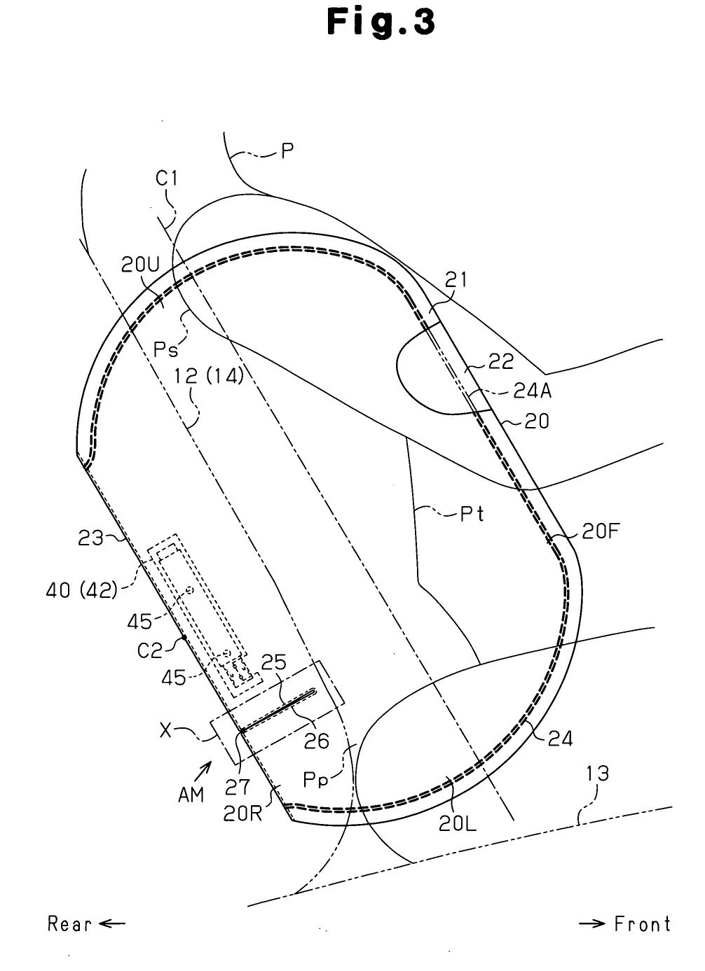

The vehicle seat 12 includes a seat cushion (seat portion) 13 and a seat back (backrest portion) 14. The seat back 14 is arranged at the rear portion of the seat cushion 13. The seat back 14 has a mechanism (not shown) for adjusting the inclination with respect to the seat cushion 13. A storage portion 15 is provided in an outer side portion of the seat back 14. An airbag module AM, which is a main part of the side airbag apparatus, is stored in the storage portion 15 of the seat back 14. The storage portion 15 is located in the vicinity of an outer side of an occupant P seated on the vehicle seat 12. The airbag module AM includes an airbag 20 and an inflator assembly 40 as shown in FIG. 3.

The components shown above will now be described. In the present embodiment, the up-down direction and the front-rear direction of the airbag module AM and its components are defined with reference to the seat back 14 of the vehicle seat 12. The up-down direction refers to the direction in which the seat back 14 extends upward, and the front-rear direction is perpendicular to the up-down direction. The seat back 14 is normally used in an inclined state. The term “up-down direction” here is therefore not vertical, but is slightly inclined. Likewise, the front-rear direction is not strictly a horizontal direction, but is slightly inclined.

### <Airbag 20>

The airbag 20 is formed by overlapping two base fabric sheets 21, 22, which are elongated in the vertical direction, and joining the peripheral portions. The base fabric sheets 21, 22 are connected to each other at a rear side 23, which extends substantially in the up-down direction. The airbag 20, which has such a shape, is referred to as a flat bag.

The base fabric sheets 21, 22 are formed of material having high strength and flexibility so as to be easily folded. Concrete examples of the material for the base fabric sheets 21, 22 include, for example, polyester thread, polyamide thread, and the like. The shape and the size of the base fabric sheets 21, 22 are determined such that, when the airbag 20 is inflated and deployed between the vehicle seat 12 and the body side portion 11, the airbag 20 covers the lumbar region Pp and a shoulder Ps of the occupant P seated on the vehicle seat 12. The airbag 20 may be formed by overlapping two independent base fabric sheets 21, 22, and joining the peripheral portions of the sheets 21, 22.

In the joining portion of the base fabric sheets 21, 22 (hereinafter, referred to as a peripheral joining portion 24), the peripheries of the base fabric sheets 21, 22 are sewn to each other with sewing threads. FIG. 3 is a view from which a part of the outer base fabric sheet 21 is cut away so as to show the inner side base fabric sheet 22. The peripheral joining portion 24 of the inner side base fabric sheet 22 is indicated by line with dashes that alternate between one long and two short dashes 24A. The peripheral joining portion 24 may be formed with means other than sewing threads. For example, the peripheral joining portion 24 may be formed by adhering the base fabric sheets 21, 22 using adhesive.

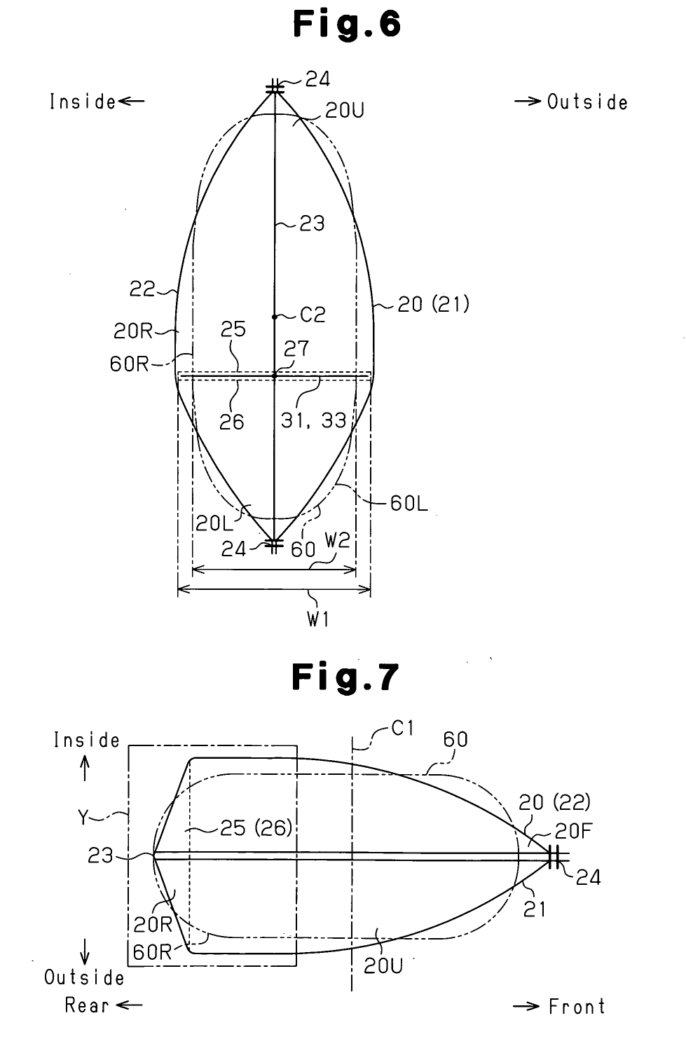

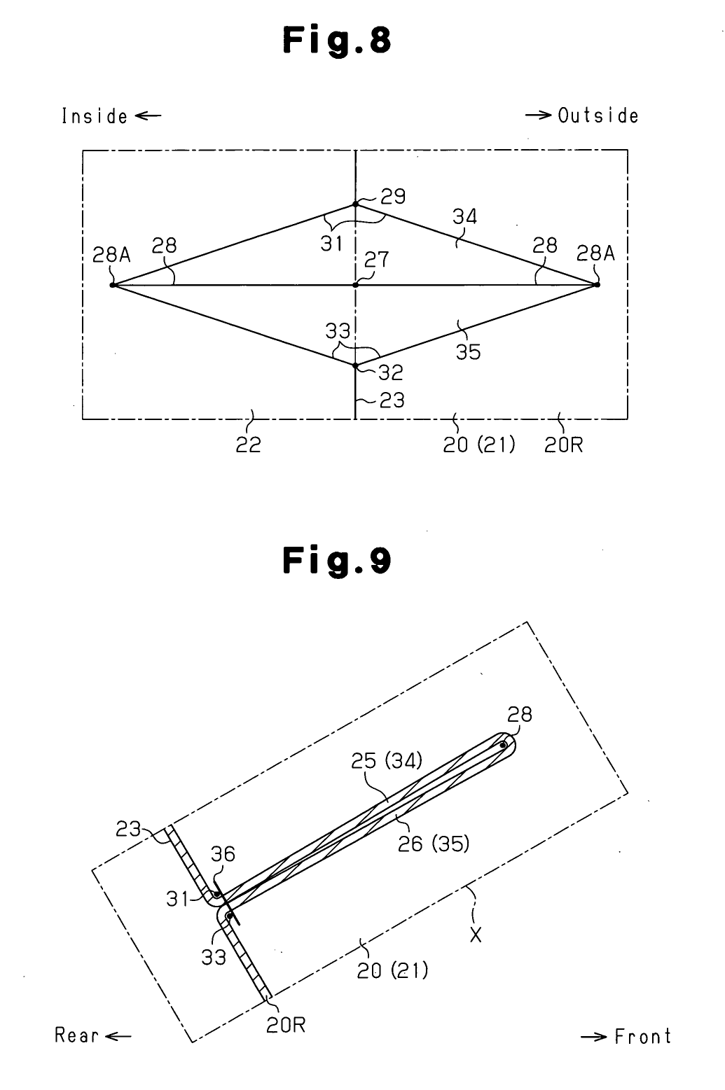

As shown in FIGS. 3 and 7, a center portion of the airbag 20 with respect to the front-rear direction is indicated by C1. A pair of tucked portions 25, 26 are formed in a portion of the airbag 20 that is rearward of the center portion C1. As shown in FIGS. 3 and 6, a center portion of a rear portion 20R of the airbag 20 with respect to the up-down direction is indicated by C2. The tucked portions 25, 26 are located below the center portion C2 of the airbag 20. The tucked portions 25, 26 are formed by folding parts of the rear portion 20R forward and into the airbag 20. FIG. 8 shows the airbag 20 prior to the formation of the tucked portions 25, 26, with the rear portions of the base fabric sheets 21, 22 spread.

As shown in FIGS. 3, 6, and 8, a pair of valley fold lines 28 are defined in the rear portions of the base fabric sheets 21, 22. The valley fold lines 28 extend laterally, that is, inward and outward, from a starting point, or a point 27 that is located below the center portion C2 on the rear side 23 of the base fabric sheets 21, 22. In the rear portions of the base fabric sheets 21, 22, a pair of upper mountain fold lines 31 and a pair of lower mountain fold lines 33 are defined. The upper mountain fold lines 31 connect a point 29 that is located on the rear side 23 and above the point 27 of the base fabric sheets 21, 22 with extension ends 28A of the valley fold lines 28. The lower mountain fold lines 33 connect a point 32 that is located on the rear side 23 and below the point 27 of the base fabric sheets 21, 22 with the extension ends 28A of the valley fold lines 28. The upper mountain fold lines 31 and the lower mountain fold lines 33 are both defined to extend astride both base fabric sheets 21, 22. The upper mountain fold lines 31 and the lower mountain fold lines 33 correspond to fold lines recited in CLAIMS. When the base fabric sheets 21, 22 are spread flat, the upper mountain fold lines 31 and the lower mountain fold lines 33 are vertically symmetrical with respect to the valley fold lines 28.

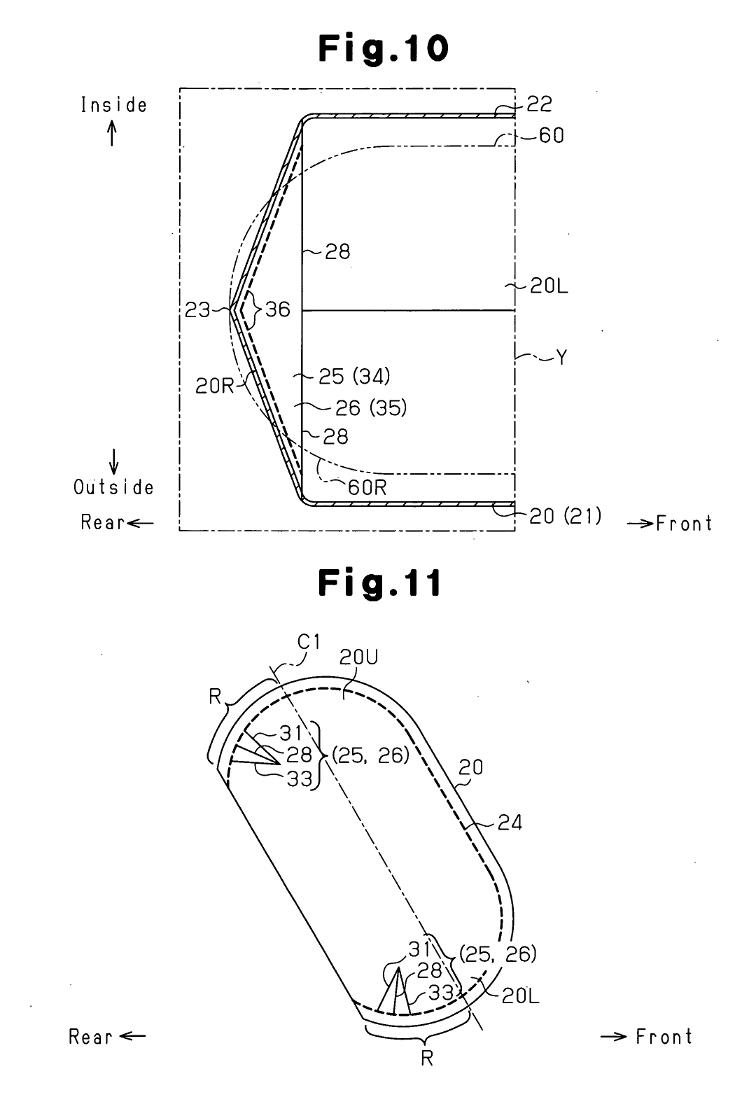

As shown in FIGS. 9 and 10, the base fabric sheets 21, 22 are mountain folded along the upper mountain fold lines 31 and valley folded along the valley fold lines 28, so that a portion 34 surrounded by the upper mountain fold lines 31 and the valley fold lines 28 is tucked into the airbag 20. Also, the base fabric sheets 21, 22 are mountain folded along the lower mountain fold lines 33 and valley folded along the valley fold lines 28, so that a portion 35 surrounded by the lower mountain fold lines 33 and the valley fold lines 28 is also tucked into the airbag 20.

As described above, in the rear portion 20R of the airbag 20, the base fabric sheets 21, 22 are valley folded along the valley fold lines 28 and mountain folded along the upper mountain fold lines 31 and the lower mountain fold lines 33. Accordingly, the upper and lower mountain fold lines 31, 33 appear adjacent to each other on the surface of the rear portion 20R of the airbag 20. The valley fold lines 28 are concealed at positions in the airbag 20 that are substantially forward of the upper and lower mountain fold lines 31, 33. The valley fold lines 28 extend linearly along the lateral direction in the rear portion 20R of the airbag 20.

As shown in FIGS. 7 and 10, the portion 34 surrounded by the upper mountain fold lines 31 and the valley fold lines 28 forms the upper tucked portion 25, which has a substantially triangular flat shape. The portion 35 surrounded by the lower mountain fold lines 33 and the valley fold lines 28 forms the lower tucked portion 26, which has the same shape as the upper tucked portion 25. The lower tucked portion 26 is stacked onto the lower side of the upper tucked portion 25.

As shown in FIGS. 9 and 10, the tucked portions 25, 26 are joined to each other in the airbag 20 by an inner joining portion 36. The inner joining portion 36 is provided along the upper mountain fold lines 31 and the lower mountain fold lines 33 of the tucked portions 25, 26. The inner joining portion 36 corresponds to a joining portion recited in CLAIMS. The inner joining portion 36 is formed by joining the tucked portions 25, 26 to each other with sewing threads along the upper mountain fold lines 31 and the lower mountain fold lines 33 of the tucked portions 25, 26.

As shown in FIG. 6, the width of the tucked portions 25, 26 when the airbag 20 is inflated, that is, the total length W1 of the valley fold lines 28 is greater than the width W2 of an airbag 60 (indicated by line with dashes that alternate between one long and two short dashes in FIG. 6) having no tucked portions 25, 26 when inflated (W1>W2).

### <Inflator Assembly 40>

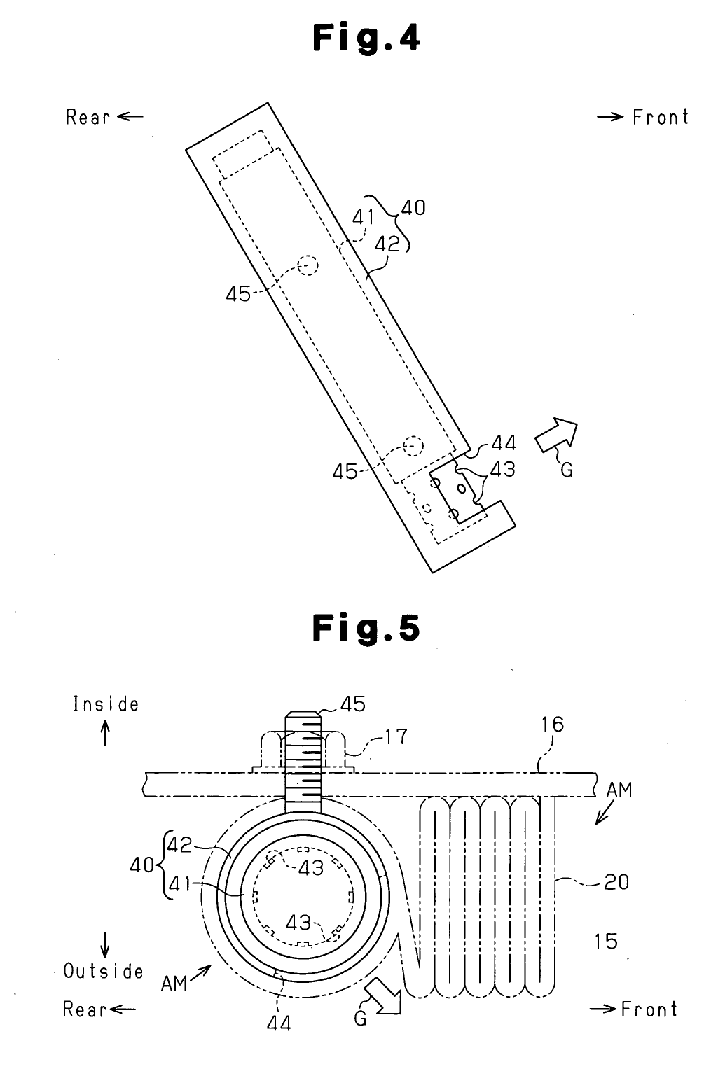

As shown in FIGS. 4 and 5, the inflator assembly 40 includes a gas source, which is an inflator 41, and a retainer 42 that surrounds the inflator 41. The inflator 41 is substantially formed like a thin column. The inflator 41 stores a gas generating agent (not shown). The inflator 41 generates the inflation gas G by combustion reaction of the gas generating agent. A plurality of gas ports 43 are formed at the lower end of the inflator 41. The generated inflation gas G in the inflator 41 is ejected outward through the gas ports 43. In place of the type using the gas generating agent, it is possible to use a type of inflator that breaks a partition wall of a high-pressure gas cylinder filled with a high-pressure gas by explosive so as to jet out the inflation gas G.

The retainer 42 functions as a diffuser. The retainer 42 secures the inflator 41 to a seat frame 16 in the seat back 14 together with the airbag 20 (refer to lines with dashes that alternate between one long and two short dashes in FIG. 5). The retainer 42 is substantially formed like a thin cylinder. The retainer 42 is formed by bending a metal plate. A window 44 is formed at the lower end of the retainer 42. Some of the gas ports 43 of the inflator 41 are exposed through the window 44. Thus, the inflation gas G discharged from the gas ports 43 is directed forward through the window 44. The inflator 41 and the retainer 42 of the inflator assembly 40 may be integrated.

As indicated by line with dashes that alternate between one long and two short dashes in FIG. 5, the airbag module AM is made compact by folding the airbag 20 in the deployed state as shown in FIG. 3 into a storage state. The airbag module AM is folded in this manner in order that it can be stored in the storage portion 15 of the seat back 14. The retainer 42 of the airbag module AM has an implanted bolt 45. The bolt 45 is passed through the seat frame 16. A nut 17 is screwed onto the bolt 45, so that the airbag module AM in the storage state is fastened to the seat frame 16.

As shown in FIG. 1, the side airbag apparatus includes an impact sensor 51 and a controller 52 in addition to the above described airbag module AM. The impact sensor 51 is configured by, for example, an acceleration sensor, and is provided in the body side portion 11 of the vehicle (see FIG. 2). The impact sensor 51 detects an impact applied to the body side portion 11 from the exterior. The controller 52 controls the operation of the inflator 41 based on a detection signal from the impact sensor 51.

In the side airbag apparatus according to the present embodiment, the impact sensor 51 detects that an impact of a magnitude greater than or equal to a predetermined value has been applied to the body side portion 11 of the vehicle. Then, based on a detection signal from the impact sensor 51, the controller 52 sends a command signal to the inflator 41 to activate the inflator 41. In response to the command signal, the gas generating agent in the inflator 41 generates inflation gas G. The inflation gas G is then jetted out through the gas ports 43. As shown in FIGS. 4 and 5, the inflation gas G is conducted substantially forward through the window 44 of the retainer 42.

The inflation gas G inflates each section of the airbag 20 in the storage state. The airbag 20 is then deployed while being unfolded. As indicated by lines with dashes that alternate between one long and two short dashes in FIGS. 1 and 2, the airbag 20 is inflated and deployed in a space between the vehicle body side portion 11 and the vehicle seat 12, while leaving its rear portion in the storage portion 15.

The lines with dashes that alternate between one long and two short dashes in FIGS. 6 and 7 indicate a case of an airbag formed by joining peripheral portions of a pair of base fabric sheet (airbag 60 having no tucked portions 25, 26). In this case, the airbag 60 is inflated to have a curved shape with a large curvature. Therefore, the dimensions of the airbag 60 in the up-down direction and the front-rear direction are both less than those of the airbag 60 when deployed without being filled with inflation gas G.

In the present embodiment, the tucked portions 25, 26 are located rearward of the center portion C1 of the airbag 20 in the front-rear direction. This increases the rigidity of a portion in the vicinity of the tucked portions 25, 26. In addition, the width W1 of a portion of the airbag 20 in the vicinity of the tucked portions 25, 26 is determined to meet the above described condition (W1>W2). Thus, in the vicinity of the tucked portions 25, 26, the airbag 20 is inflated to be thicker in the lateral direction than a rear portion 60R of the airbag 60. On the other hand, a front portion 20F, a lower portion 20L, and an upper portion 20U of the airbag 20, which are distant from the tucked portions 25, 26, are inflated into a tapered shape under the influence of the wide inflation in the vicinity of the tucked portions 25, 26 in the lateral direction. Therefore, as shown in FIG. 2, the airbag 20 easily enters a narrow gap G1 between the occupant P and the body side portion 11. In this manner, the airbag 20 enters the gap G1, and the tucked portions 25, 26 of the airbag 20, which have been widely inflated in the lateral direction, are located on the outer side of the occupant P. The airbag 20 thus restrains the occupant P.

In the present embodiment, the airbag 20 has a portion that is inflated and deployed on the outer side of the lumbar region Pp of the occupant P. Particularly, since the lower portion 20L of the airbag 20, which is distant from the tucked portions 25, 26, is inflated into a tapered shape, the airbag 20 is allowed to enter the narrow gap G between the lumbar region Pp of the occupant P and the body side portion 11. The tucked portions 25, 26, which have been widely inflated in the lateral direction, are located on the outer side of the lumbar region Pp. This allows the airbag 20 to reliably restrain the lumbar region Pp of the occupant P.

The present embodiment described above has the following advantages.

(1) In the present embodiment, the rear portion 20R of the airbag 20 is folded to form the tucked portions 25, 26, which are stacked vertically and joined to each other. Further, the width W1 of the tucked portions 25, 26 when the airbag 20 is inflated is greater than the width W2 of the airbag 60 having no tucked portions 25, 26 when inflated (W1>W2).

Thus, a portion including the tucked portions 25, 26, which are located rearward of the center portion C1 of the airbag 20, can be widely inflated in the lateral direction. This ensures the restraining performance of the airbag 20. Also, the front portion 20F, the lower portion 20L, and the upper portion 20U of the airbag 20, which are distant from the tucked portions 25, 26, can be inflated into a tapered shape. This allows the front portion 20F, the lower portion 20L, and the upper portion 20U of the airbag 20 are allowed to easily enter the narrow gap G1 between the occupant P and the body side portion 11. This improves the deployment performance of the airbag 20.

(2) The airbag 20 has the tucked portions 25, 26 at a portion that is inflated and deployed on the outer side of the lumbar region Pp of the occupant P. Since the lower portion 20L of the airbag 20 is inflated into a tapered shape, the airbag 20 is reliably allowed to enter the narrow gap G1 between the body side portion 11 and the lumbar region Pp. This improves the deployment performance of the airbag 20. Also, since the lumbar region Pp is restrained by the tucked portions 25, 26, which have been widely inflated in the lateral direction, the restraining performance of the airbag 20 is improved. That is, the airbag 20 reliably protects the lumbar region Pp of the occupant P from an impact due to side collision.

(3) In the case of a prior art side airbag apparatus, in which an airbag has a three-dimensional shape with an increased number of base fabric sheets, the additional base fabric sheets each need to be sewn to other base fabric sheets at the periphery. In this case, the airbag is harder in the sewn portions than in non-sewn portions, and the sewn portions enlarge the area of increased thickness of the airbag. This makes the process for folding the airbag into a storage state troublesome.

In this regard, parts (the portions 34, 35) of the airbag 20 (the base fabric sheets 21, 22) of the present embodiment are formed into the tucked portions 25, 26. In this case, the tucked portions 25, 26 can be joined to each other simply by sewing along the upper and lower mountain fold lines 31, 33. Thus, the airbag 20 is hardened by a small degree due to sewing. Also, in a state where the airbag 20 is folded, the area in which the thickness of the airbag 20 is increased by sewn portions is reduced. Thus, compared to airbags having a three-dimensional shape, the airbag 20 is easily folded. Even if the tucked portions 25, 26 are joined by adhesion instead of sewing, the above described advantages are achieved.

(4) The side airbag apparatus according to the present embodiment is superior to a case where the tucked portions 25, 26 are located in the front portion 20F of the airbag 20 in terms of the following items. That is, the rigidity of a portion in which the tucked portions 25, 26 are vertically stacked and sewn to each other is higher than that in other portions. If such a sewn portion exists in the front portion 20F of the airbag 20, the sewn portion passes through the gap G1 between the occupant P and the body side portion 11, while contacting the occupant P. In this respect, the tucked portions 25, 26 are located only in the rear portion 20R of the airbag 20 in the present embodiment. This reduces the likelihood of contact between a sewn portion and the occupant P.

(5) A part of the rear portion 20R of the airbag 20 is folded inward so that the tucked portions 25, 26 are formed. Further, the tucked portions 25, 26 are sewn to each other along the upper and lower mountain fold lines 31, 33 while being vertically stacked. The tucked portions 25, 26 are therefore located in the airbag 20. Therefore, a bulge formed by the tucked portions 25, 26 is not exposed to the outside of the airbag 20. This eliminates drawbacks caused by contact between the tucked portions 25, 26 and other members.

(6) The inner joining portion 36 is formed by sewing along the upper and lower mountain fold lines 31, 33. The inner joining portion 36 joins the tucked portions 25, 26 to each other in a vertically stacked state. That is, the tucked portions 25, 26 can be joined to each other simply by sewing sections along the upper and lower mountain fold lines 31, 33. Thus, compared to a case where adjacent tucked portions 25, 26 are joined to each other by adhesion, the tucked portions 25, 26 are easily joined to each other.

(7) The shape of the tucked portions 25, 26 can be changed by changing the length of the valley fold lines 28 and the inclination of the upper and lower mountain fold lines 31, 33 of the base fabric sheets 21, 22. The thickness of the tucked portions 25, 26 in the inflated state of the airbag 20 can be changed through such a simple procedure.

The present invention may be embodied in the following forms.

The tucked portions 25, 26 may be located at any position that is rearward of the center portion C1 of the airbag 20. For example, the tucked portions 25, 26 may be located above the center portion C2 of the airbag 20.

FIG. 11 shows an airbag 20, in which an arcuate upper portion 20U and an arcuate lower portion 20L of the airbag 20 are deployed. In the airbag 20 of this configuration, upper and lower mountain fold lines 31, 33 and valley fold lines 28 may be defined in a section R, which is rearward of the center portion C1 in the periphery of the upper and lower portions 20U, 20L. In this case, the fold lines 31, 33, 28 are folded to provide tucked portions 25, 26. In this case, tucked portions 25, 26 may be formed in only one of the upper portion 20U and the lower portion 20L of the airbag 20. Further, in the case of an airbag 20 in which the peripheral portion of the upper portion 20U or the lower portion 20L is shaped arcuately, tucked portions 25, 26 may be formed only in the arcuate peripheral portion (section R).

A plurality of tucked portions 25, 26 may be provided in the rear portion 20R of the airbag 20. FIG. 11 shows an airbag 20 having tucked portions 25, 26 at two positions.

The tucked portions 25, 26 may be folded rearward and to the exterior of the airbag 20. In this case, the tucked portions 25, 26 bulge to the exterior of the airbag 20. However, the same operations and advantages as the above illustrated embodiment are achieved.

The rear portion 20R of the airbag 20 may be folded two or more times to form two or more pairs of tucked portions, and the pairs of the tucked portions may be vertically stacked and joined to each other.

Instead of sewing the tucked portions 25, 26 to each other along the upper and lower mountain fold lines 31, 33, the tucked portions 25, 26 may be adhered to each other using adhesive.

In the above illustrated embodiment, the tucked portions 25, 26 are joined to each other along the upper and lower mountain fold lines 31, 33. However, the tucked portions 25, 26 may be joined to each other at other sections. In this case, means for joining includes sewing and adhesion. For example, the tucked portions 25, 26 may be adhered to each other in the entire portions 34, 35.

Instead of the lateral width of the tucked portions 25, 26 when the airbag 20 is inflated, the lateral width in the vicinity of the tucked portions 25, 26 may be set as the width W1. In this case also, the width W1 is set to be greater than the lateral width W2 of the rear portion 60R of the airbag 60 having no tucked portion when the airbag 60 is inflated.

The storage portion 15 may be provided in the body side portion 11. In this case, the storage portion 15 is located in the vicinity of an outer side of an occupant P seated on the vehicle seat 12.

The present invention may be applied to a side airbag apparatus equipped with an airbag 20 having no portion for protecting the lumbar region Pp of the occupant P. In this case also, the deployment performance of the airbag 20 is improved while maintaining the restraining performance.

1. A side airbag apparatus comprising: an airbag that is formed by stacking a connected pair of base fabric sheets or a pair of independent fabric sheets, and joining peripheral portions of the base fabric sheets, the airbag being stored in a storage portion located in the vicinity of an outer side of an occupant seated on a vehicle seat; and an inflator that supplies inflation gas to the airbag in response to an impact applied to the vehicle from the exterior, wherein the airbag is inflated and deployed between a body side portion of the vehicle and the vehicle seat, the side airbag apparatus further comprising:
at least one pair of tucked portions located rearward of a center portion of the airbag, the tucked portions being formed by folding a part of the airbag; and
a joining portion for joining the tucked portions to each other in a vertically stacked state,
wherein the width of the airbag along the widthwise direction of the vehicle in the vicinity of the tucked portions when the airbag is inflated is larger than the width of a rear portion of an airbag having no tucked portion along the widthwise direction of the vehicle when the airbag is inflated.

2. The side airbag apparatus according to claim 1,
wherein the tucked portions are folded forward and into the airbag.

3. The side airbag apparatus according to claim 1,
wherein the airbag has a portion that is inflated and deployed on the outer side of the lumbar region of the occupant.

4. The side airbag apparatus according to claim 1,
wherein the tucked portions are formed by folding, in a section rearward of the center portion of the airbag, the base fabric sheets along a fold line that extends astride both base fabric sheets, and
the joining portion is formed by sewing the tucked portions adjacent to each other along the fold line.
